(19) United States
(12) Patent Application Publication
(10) Pub. No.: US 2018/0347280 A1
(43) Pub. Date: Dec. 6, 2018

(54) BOREHOLE DRILLING USING ACTUAL EFFECTIVE TILT ANGLES

(71) Applicant: Schlumberger Technology Corporation, Sugar Land, TX (US)

(72) Inventors: Helen Xiaoyan Zhong, Sugar Land, TX (US); Steve F. Crary, Al-Khobar (SA); Mark T. Frey, Sugar Land, TX (US)

(21) Appl. No.: 15/764,832

(22) PCT Filed: Sep. 26, 2016
(86) PCT No.: PCT/US2016/053651

§ 371 Date: Mar. 29, 2018

Related U.S. Application Data
(60) Provisional application No. 62/235,245, filed on Sep. 30, 2015.

(51) Int. Cl. E21B 7/04; G01V 3/38

(52) U.S. Cl. CPC E21B 7/04; G01V 11/005; G01V 3/38

(57) ABSTRACT

A drill string can include an electromagnetic transmitter oriented at an actual effective tilt angle with respect to the drill string and an electromagnetic receiver oriented at an actual effective tilt angle with respect to the drill string. The transmitter and received can be used to investigate geologic formations surrounding the drill string, and measurements of the geologic formations can be based on the actual effective tilt angles of the transmitter and the receiver. Forward modelling software can use the actual effective tilt angles of the transmitter and the receiver to predict measurements of the geologic formations

### CROSS-REFERENCE TO RELATED APPLICATIONS

The present application claims priority to U.S. Provisional Application 52/235,245 filed Sep. 30, 2015, the entirety of which is incorporated by reference.

### FIELD OF THE INVENTION

Some embodiments described herein generally relate to LWD systems and techniques that allow geologic formations to be investigated.

### BACKGROUND

In the drilling of oil and gas wells, LWD and numerical forward modeling techniques can be used to improve wellbore placement. Such techniques can include the use of electromagnetic transmitters and receivers included within a drill string. The electromagnetic transmitters can transmit electromagnetic waves into the earth surrounding the drill string, and the electromagnetic receivers can receive reflected or otherwise returned portions of the transmitted electromagnetic waves. The receivers can generate voltages based on the electromagnetic waves they receive and the voltages can be used to calculate useful measurements about the earth surrounding the drill string. These measurements can be used to guide drilling operations and improve placement of a wellbore.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one non-limiting embodiment, a method can include drilling a borehole with a drill string including an antenna. The method can further include predicting voltages to be outputted by the antenna of the drill string during logging while drilling investigations of a geologic formation using an actual effective tilt angle of the antenna. The method can further include processing the predicted voltages to generate predicted measurements of the geologic formation.

In another non-limiting embodiment, a method can include emitting electromagnetic waves from a drill string including an antenna while the drill string is used to drill a borehole. The method can further include receiving portions of the emitted electromagnetic waves returned to the antenna from a geologic formation. The method can further include outputting voltages corresponding to the received portions of the emitted electromagnetic waves from the antenna. The method can further include processing the outputted voltages to generate measurements of the geologic formation using an actual effective tilt angle of the antenna.

In another non-limiting embodiment, a system can include a drill string including an antenna, the drill string positioned within a borehole. The system can further include a forward modelling simulation to predict voltages to be outputted by the antenna during logging while drilling investigations of a geologic formation using an actual effective tilt angle of the antenna and to process the predicted voltages to generate predicted measurements of the geologic formation.

### BRIEF DESCRIPTION OF THE SEVERAL VIEWS OF THE DRAWINGS

In the drawings, sizes, shapes, and relative positions of elements are not drawn to scale. For example, the shapes of various elements and angles are not drawn to scale, and some of these elements may have been arbitrarily enlarged and positioned to improve drawing legibility.

FIG. 1 depicts a portion of a drill string according to one or more embodiments disclosed herein;

FIG. 2 depicts a method of using the drill string of FIG. 1 according to one or more embodiments disclosed herein; and

FIG. 3 depicts results of numerical modelling simulations according to one or more embodiments disclosed herein.

### DETAILED DESCRIPTION

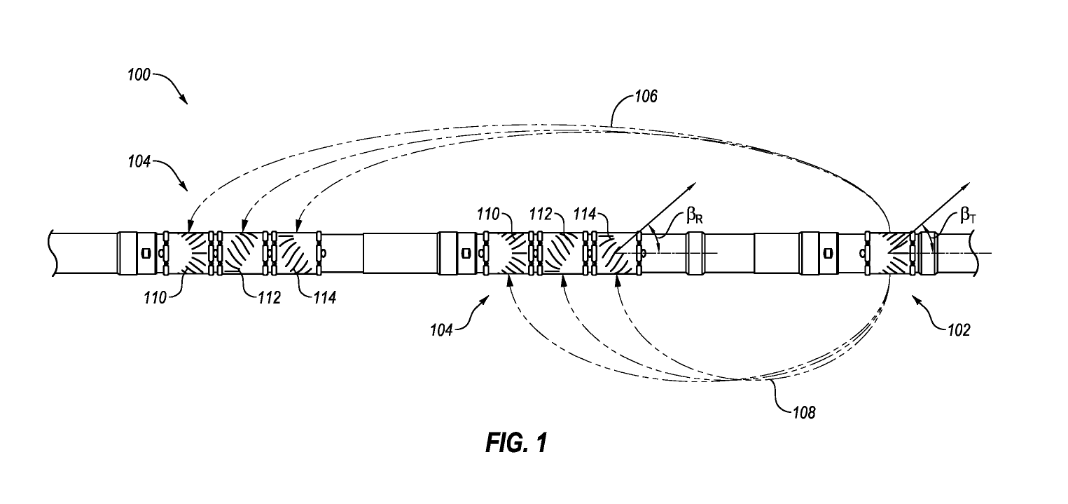

FIG. 1 illustrates a portion of a drill string 100 that can be used to drill or bore into the earth, such as to form a wellbore of an oil well. The drill string 100 can include various components, modules, and subassemblies, such as a bottomhole assembly having a drill bit (not illustrated). The drill string 100 can be used with land-based drilling rigs, ocean-based drilling rigs, or generally, any suitable drilling rig. The drill string 100 can form a wellbore by rotary drilling, directional drilling, or generally, any suitable type of borehole drilling, to drill vertical, curved, or horizontal boreholes.

FIG. 1 illustrates that the drill string 100 can include an electromagnetic transmitter 102 that is capable of emitting electromagnetic waves 106, 108 as the drill string 100 is operated to drill the borehole. The transmitter 102 can emit electromagnetic waves that propagate out of the drill string 100 and into the earth surrounding the borehole being drilled by the drill string 100. FIG. 1 also illustrates that the drill string 100 can include a plurality of electromagnetic receivers 104, each of which includes three antennas 110, 112, and 114, that are capable of receiving the electromagnetic waves 106, 108 as the drill string 100 is operated to drill the borehole. The electromagnetic waves 106, 108 emitted by the transmitter 102 can propagate away from the drill string 100 and into the earth, where they can be reflected or otherwise returned back toward the drill string 100 by features of the surrounding earth. The reflected or otherwise returned electromagnetic waves 106, 108 can be received by the antennas 110, 112, 114, to facilitate the investigation and study of properties of the surrounding earth, such as in logging while drilling (LWD) techniques. For example, such techniques can be used to investigate the locations and properties of target reservoirs as a borehole is drilled to allow real-time or near-real-time adjustment of a drilling direction to improve wellbore placement.

In one implementation, the electromagnetic transmitter 102 can include a coiled wire that emits electromagnetic waves when driven with an electric current, although the electromagnetic transmitter 102 can include any suitable device capable of emitting electromagnetic waves. In one implementation, the antennas 110, 112, and 114 can each include a coiled wire across which a voltage is generated (and a current results if the coiled wire forms a completed circuit) when it receives electromagnetic waves, although the antennas 110, 112, and 114 can each include any suitable device capable of receiving electromagnetic waves and producing a useful electric signal. The drill string 100 includes one transmitter 102 and two receivers 104 each having three antennas, although in other implementations, a drill string can include any suitable number of transmitters, any suitable number of receivers, and any suitable number of antennas per receiver.

In many cases, the transmitter 102 and each of the antennas 110, 112, and 114 can be tilted with respect to the drill string 100. For example, a central axis of a coiled wire of the transmitter 102 and each of the antennas 110, 112, and 114 can be oriented at a physical tilt angle with respect to a central longitudinal axis of the drill string 100. An actual effective tilt angle β, which is referred to herein simply as a tilt angle β to distinguish it from a physical tilt angle, corresponds to a dipole response of the coiled wire and can be determined from measurements of the physical tilt angle and a shield incorporated into the drill string 100. For clarity, a tilt angle β of a transmitter can be signified as PT and a tilt angle β of an antenna can be signified as β_{R}. Tilt angles are discussed in greater detail below. In implementations in which the receivers 104 include plural antennas, the antennas can be rotationally offset (e.g., equiangularly offset) from one another about the central longitudinal axis of the drill string 100. For example, if a receiver 104 includes two antennas, then the projections of the central axes of their coiled wires into a plane perpendicular to the central longitudinal axis of the drill string 100 can be offset from one another by 180°. As another example, if a receiver 104 includes three antennas (e.g., as shown in the illustrated embodiment), then the projections of the central axes of their coiled wires into a plane perpendicular to the central longitudinal axis of the drill string 100 can be offset from one another by 120°. Any suitable number of antennas can be used in a receiver in this manner.

Further, each antenna 110, 112, 114 can be rotationally offset from the transmitter 102 about the central longitudinal axis of the drill string 100. For example, the projections of the central axes of the coiled wires of the antenna 110 and the transmitter 102 into a plane perpendicular to the central longitudinal axis of the drill string 100 can be offset from one another by an alignment angle α, where the angle α is positive in a clockwise direction looking down the drill string toward the drill bit. In this embodiment, the projections of the central axes of the coiled wires of the antenna 112 and the transmitter 102 into a plane perpendicular to the central longitudinal axis of the drill string 100 can be offset from one another by an angle α−120° and the projections of the central axes of the coiled wires of the antenna 114 and the transmitter 102 into a plane perpendicular to the central longitudinal axis of the drill string 100 can be offset from one another by an angle α−240°.

The transmitter 102 and the antennas 110, 112, and 114 can rotate as the drill string 100 rotates to drill a borehole. Thus, while the angle α can remain constant throughout a drilling operation, the orientations of the drill string 100, the transmitter 102, and the antennas 110, 112, and 114, with respect to the ground surface, operators and equipment located at the ground surface, and the features of the earth being investigated, can be constantly changing. Thus, an angle φ can be used to signify an angle of rotation of the drill string 100 with respect to a datum orientation and an angle γ can be used to signify an angle of rotation of the projection of the central axis of the transmitter 102 into a plane perpendicular to the central longitudinal axis of the drill string 100 with respect to the datum orientation.

Raw voltages generated by the antennas 110, 112, and 114 can be accepted as inputs into one or more electronic devices or computers, which can process the raw voltage data to transform it into useful physical measurements that characterize the geologic formations of interest. These physical measurements can be used by drill string operators to improve wellbore placement or can be provided as inputs into modelling software for further processing. As examples, the raw voltage data can be processed to provide drill string operators or modelling software with physical measurements such as symmetrized directional attenuation (referred to herein as “USDA”), anti-symmetrized directional attenuation (referred to herein as “UADA”), harmonic resistivity attenuation (referred to herein as “UHRA”), harmonic anisotropy attenuation (referred to herein as “UHAA”), 3D-directional attenuation (referred to herein as “3DFA”), symmetrized directional phase shift (referred to herein as “USDP”), anti-symmetrized directional phase shift (referred to herein as “UADP”), harmonic resistivity phase shift (referred to herein as “UHRP”), harmonic anisotropy phase shift (referred to herein as “DHAP”), or 3D-directional phase shift (referred to herein as “3DFP”). LWD techniques using electromagnetic transmitter(s) and receiver(s), as described herein, can allow these measurements to be determined at distances up to at least 200 feet from the drill string 100.

Further, in some drilling operations, numerical forward modeling simulations can be used to predict properties of the geologic formations surrounding the borehole that have not yet been encountered by the drill string or measured using LWD techniques (e.g., using the transmitter 102 and receivers 104 as described above). The software can provide drill string operators with additional and/or improved information and thus can allow the operators to achieve improvements in wellbore placement. The software can be provided with initial input from various sources, such as previous exploratory studies of the geologic formations of interest, and can be updated in real-time or in near-real-time with new measurements made by LWD techniques as the borehole is being drilled. Based on this input, the software can predict, and can continuously refine its predictions of, the properties of the geologic formations of interest.

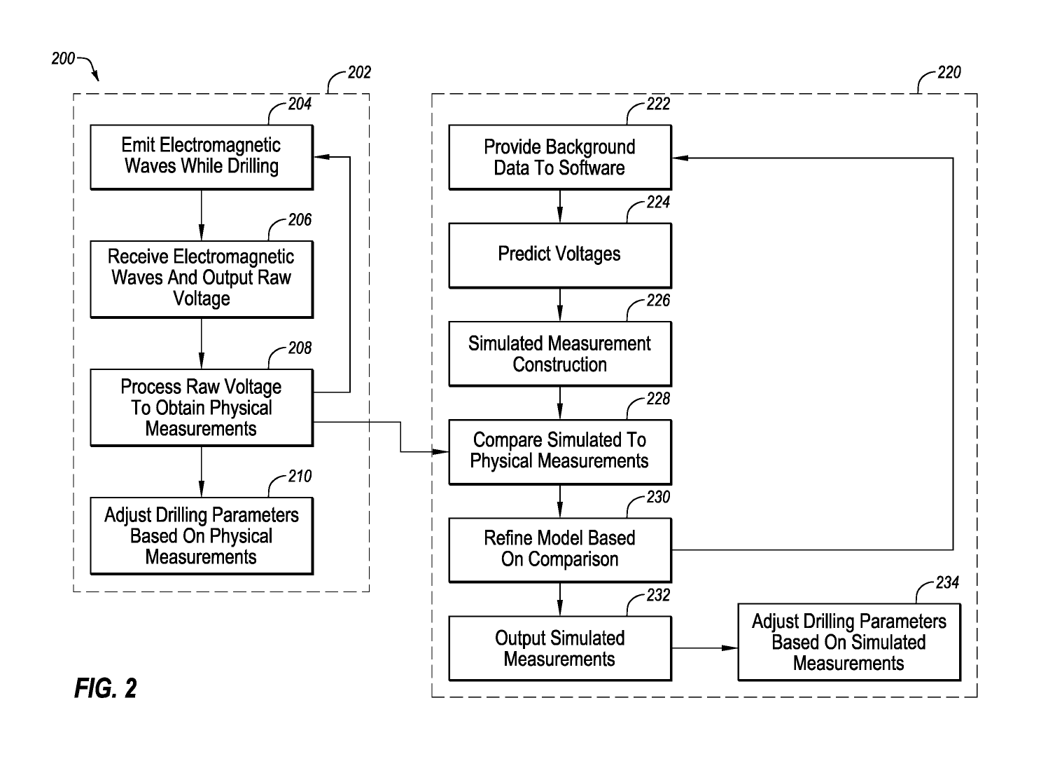

FIG. 2 illustrates an example method 200 of drilling a wellbore. Method 200 can include two main, interacting process loops, namely, a physical measurement loop 202 that can be performed down-hole using the drill string 100 and firmware embedded therein, and a forward modeling loop 220 that can be performed at the ground surface using a computer and software running thereon. The physical measurement loop 202 can include emitting electromagnetic waves 106, 108, such as by using the transmitter 102, while drilling a borehole using the drill string 100, at box 204. The physical measurement loop 202 can also include receiving returned portions of the emitted electromagnetic waves 106, 108, such as by using one or more of the antennas 110, 112, 114, which can output raw voltages, at box 206. The physical measurement loop 202 can also include processing the raw voltages to obtain useful physical measurements, referred to as physical measurement construction, at box 208. The physical measurement loop 202 can also include adjusting parameters of the drilling operation based on the physical measurements to improve wellbore placement, at box 210. Parameters of the drilling operation that can be adjusted include a drilling rate or a drilling direction. The physical measurement loop 202 can operate as a loop, returning to box 204 after completing box 208, or the physical measurement loop 202 can operate continuously, such that electromagnetic waves are continuously emitted and received, and such that raw voltages are continuously outputted and processed.

The forward modelling loop 220, which can also be referred to herein as an “inversion loop” or “inversion workflow,” can include providing a numerical forward modelling simulation with background information regarding the geologic formations surrounding the drill string 100 or surrounding the borehole being drilled or to be drilled, at box 222. The forward modelling loop 220 can also include using the numerical forward modelling simulation and the background information to predict or simulate voltages that will be output by antennas investigating the geologic formations using LWD techniques, at box 224. The forward modelling loop 220 can also include processing the predicted voltages to obtain predicted or simulated measurements, referred to as predicted or simulated measurement construction, at box 226. The forward modelling loop 220 can also include comparing the physical measurements produced at box 208 to the predicted measurements produced at box 226, at box 228. The forward modelling loop 220 can also include refining the numerical forward modelling simulation based on the results of the comparison of box 228, at box 230. The forward modelling loop 220 can also include outputting the simulated measurements, at box 232. The forward modelling loop 220 can also include adjusting parameters of the drilling operation based on the predicted measurements to improve wellbore placement, at box 234. The forward modelling loop 220 can operate as a loop, returning to box 222 after completing box 230, or the forward modelling loop 220 can operate continuously.

Raw voltages generated by the antennas 110, 112, and 114 are a function of the electromagnetic waves they receive as well as their respective tilt angles. The tilt angles of the antennas 110, 112, and 114 are also parameters used in other portions of the method 200. As a first example, the tilt angles are used in physical measurement construction to compute the physical measurements from the raw voltages at box 208. As a second example, the tilt angles are used by the numerical forward modelling simulation to produce the predicted voltages at box 224. As a third example, the tilt angles are used by the numerical forward modelling simulation to produce the predicted measurements from the predicted voltages at box 226. Thus, the tilt angles are parameters that affect at least four portions of the method 200: obtaining each of the voltages and the measurements in each of the physical world and the simulation.

Tilt angles are often specified as nominally 45° and a nominal value of 45° can be used in the processing of method 200, which can simplify the mathematics used to predict voltages using the simulation software and to determine the measurements from the voltages. Actual effective tilt angles, which are referred to herein simply as tilt angles β to distinguish them from nominal tilt angles, often deviate from 45° due, for example, to differences in hardware designs and manufacturing tolerances. Tilt angles β also vary with the frequency of the electromagnetic waves used. Greater accuracy can be achieved in simulating voltages and in computing measurements from voltages in method 200, and thus better wellbore placement can ultimately be achieved, by using a tilt angle β, as determined from measurements of the physical tilt angle and any shield used in the drill string 100, in method 200 rather than a nominal tilt angle 45°. The greater accuracy can be achieved, in part, by making the simulation resemble the real world as closely as possible. For example, accuracy can be improved by using the tilt angle μ to predict voltages in the simulation, and by using either the tilt angle μ or a nominal tilt angle for both physical and simulated measurement generation.

There are seven possible ways to improve the accuracy of simulated voltages and computed measurements in method 200 over those that use a nominal 45° tilt angle, and thus improve wellbore placement, as set forth in Table 1 below:

TABLE 1
Seven Ways to Improve Computations

| | | Physical World | Simulation |
|---|---|---|---|
| 1 | Voltage Generation | — | Tilt Angle β |
| | Measurement | Tilt Angle β | Tilt Angle β |
| | Construction | | |
| 2 | Voltage Generation | — | Nominal Tilt Angle |
| | Measurement | Tilt Angle β | Tilt Angle β |
| | Construction | | |
| 3 | Voltage Generation | — | Nominal Tilt Angle |
| | Measurement | Nominal Tilt Angle | Tilt Angle β |
| | Construction | | |
| 4 | Voltage Generation | — | Nominal Tilt Angle |
| | Measurement | Tilt Angle β | Nominal Tilt Angle |
| | Construction | | |
| 5 | Voltage Generation | — | Tilt Angle β |
| | Measurement | Nominal Tilt Angle | Tilt Angle β |
| | Construction | | |
| 6 | Voltage Generation | — | Tilt Angle β |
| | Measurement | Tilt Angle β | Nominal Tilt Angle |
| | Construction | | |
| 7 | Voltage Generation | — | Tilt Angle β |
| | Measurement | Nominal Tilt Angle | Nominal Tilt Angle |
| | Construction | | |

The first option can provide the highest level of accuracy by using the tilt angle β rather than a nominal tilt angle throughout the processing of method 200. Because the tilt angle μ depends upon the specific hardware used in the drill string 100 and the frequency of the electromagnetic waves being used, however, large tables of tilt angles μ are used to track the tilt angles μ applicable to the various implementations. Thus, errors can be introduced when an applicable tilt angle μ is selected from such a large table and entered or transcribed into a computing system. Thus, while the first option can provide the highest level of accuracy in many cases, it is possible that others of the seven options listed above can reduce the chance of a transcription error being introduced into the system, while also providing improved accuracy approaching or approximately equal to that of the first option.

For example, option seven can provide a high level of accuracy approaching that of option one. This can be achieved by using the tilt angle μ to predict voltages in the simulation so that the simulation resembles the real world, in which the raw voltages are a function of the tilt angle β, and by using a nominal tilt angle for both physical and simulated measurement generation, so that the simulated measurements further resemble the physical measurements. In this way, option seven can improve the accuracy of the simulated voltages and computed measurements in method 200 over those that use the nominal tilt angle throughout the processing of method 200, and thus improve wellbore placement, while reducing the number of times the tilt angle β is transcribed as compared to the first option.

To assess the relative accuracies of the various options, three different simulation scenarios were run, namely, a first simulation in which the tilt angle β was used for both simulated voltage generation and simulated measurement construction, a second simulation in which the tilt angle β was used for simulated voltage generation and a nominal tilt angle 45° was used for simulated measurement construction, and a third simulation in which the nominal tilt angle 45° was used for both simulated voltage generation and simulated measurement construction. Each of these three simulations was run for each of two different electromagnetic wave frequencies to determine four different measurements: UHRA, UHRP, USDA, and UHAA. A simulation using the nominal tilt angle 45° for simulated voltage generation and the tilt angle β for simulated measurement construction was not run. In such a hypothetical simulation, the simulated voltages are used as inputs to the simulated measurement construction, so using the less accurate nominal tilt angle 45° in both simulated voltage generation and simulated measurement construction can be simpler than using the less accurate nominal tilt angle 45° in simulated voltage generation and the more accurate tilt angle β in simulated measurement construction.

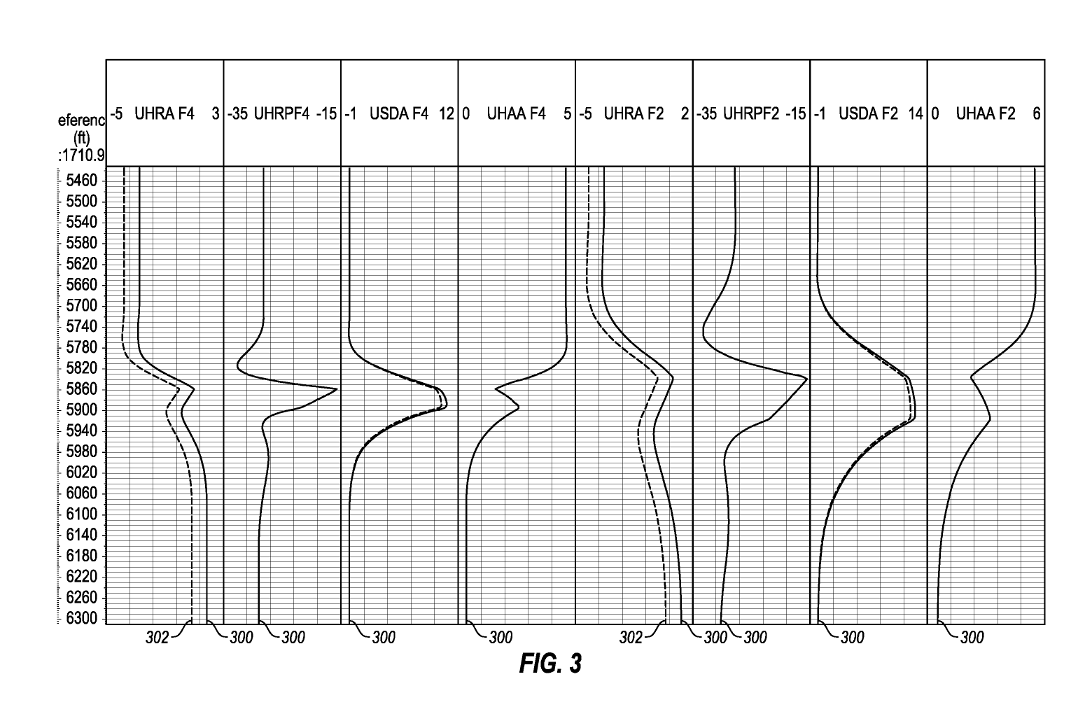

The results of the simulations are presented in FIG. 3. The results establish that for the four different measurements, using both frequencies, the first and third simulations produced nearly identical results, as indicated by reference numerals 300, while the second simulation produced results that deviate from those of the first and third simulations, particularly for the UHRA measurement, as indicated by reference numerals 302. The fact that the first and third simulations produced nearly identical results but the second simulation did not indicates that option 4 would provide improved accuracy over options 5 or 6. More specifically, the results of the three simulations establish that using the tilt angle β in both voltage generation and measurement construction is equivalent to using a nominal tilt angle in both voltage generation and measurement construction, but that neither of these options as closely approximates the use of the tilt angle β for voltage generation and the nominal tilt angle for measurement construction.

Of the seven options presented in Table 1, then, the first, fourth, and seventh options are of particular interest. From these, the seventh option allows measurement construction to use the nominal tilt angle in any implementation and thus measurement construction code can be shared between any of the various different software and firmware platforms without regard to the specific hardware being used. Further, in the seventh option, the tilt angle β is used as a parameter in just one portion of method 200, reducing the burden of tracking and updating the tilt angle β in multiple locations and reducing the effort expended to synchronize the downhole firmware and the modelling software. Further still, in the seventh option, the tilt angle β is not used in firmware located in the drill string 100 while it is downhole, allowing greater flexibility in modifying the tilt angle β during drilling.

Depending upon which of the options listed in Table 1 is selected, computational procedures can use the applicable angles (e.g., a nominal tilt angle 45°, an actual effective tilt angle, or both) to calculate the measurements of interest. Examples of suitable computational procedures are presented herein as examples. Other computational procedures can be used and may be more efficient than those presented herein. The computational procedures described herein allow measurements to be constructed from the voltages outputted from a single antenna, for a single frequency of electromagnetic waves, and the computational procedures can be repeated for each antenna from which voltages are obtained and for each frequency of electromagnetic waves used. Using multiple antennas such as antennas 110, 112, and 114 allows for redundant measurements and thus improved accuracy. The equiangular spacing of the antennas 110, 112, and 114 described above increases these potential improvements in accuracy.

In some cases, the physical measurement loop 202 of the method 200 can be operated with multiple frequencies of electromagnetic waves. For example, the physical measurement loop 202 can be operated with electromagnetic waves of 2, 6, 12, 24, 48, and 96 kHz. The measurements calculated from the voltage outputs of multiple antennas can be compared to evaluate which of the frequencies gives rise to the most consistent or accurate measurements. The frequency that gives rise to the most consistent or accurate measurements can be a function of the geology of an individual site. The physical measurement loop 202 can subsequently be operated using the frequency that gives rise to the most accurate or consistent measurements. In the following calculations, any effects of the curvature of the drill string 100 can be assumed to be negligible, or can be compensated for with additional computational procedures.

If option 1 is selected and the tilt angle β is used throughout the processing of method 200, then the following computational procedures can be used. First, a fitting coefficient can be generated as follows. The receiver-transmitter induction coupling tensor between two points in space is expressed as the following matrices product:

$${\overline{\overline{C}}}_{RT} = [ \begin{matrix}cos ϕ & sin ϕ & 0 \\ - sin ϕ & cos ϕ & 0 \\ 0 & 0 & 1\end{matrix} ] \cdot [ \begin{matrix}xx & xy & xz \\ yx & yy & yz \\ zx & zy & zz\end{matrix} ] \cdot [ \begin{matrix}cos ϕ & - sin ϕ & 0 \\ sin ϕ & cos ϕ & 0 \\ 0 & 0 & 1\end{matrix} ] \qquad ( 1 )$$

Here each component of the matrix is a complex number, representing the elementary coupling between one dimension and another. For example, (zx) means the coupling tensor when the receiver coil aligns with the z-axis and the transmitter coil aligns with the x-axis, and the (zz) coupling is the coupling where both the transmitter and receiver are aligned with the z-axis. The receiver signal V_{R} can be expressed as a product of matrices as shown below:

$${V}_{R} = {( {\vec{U}}_{T} )}^{T} {\overline{\overline{C}}}_{RT} {\vec{U}}_{R} = ( cos γ sin {β}_{T} , sin γ sin {β}_{T} , cos {β}_{T} ) \cdot {\overline{\overline{C}}}_{RT} \cdot ( \begin{matrix}cos α sin {β}_{R} \\ sin α sin {β}_{R} \\ cos {β}_{R}\end{matrix} ) \qquad ( 2 )$$

Whatever the formation is, V_{R} can be expressed as a function of tool face angle φ, by five Fourier coefficients corresponding to 1, sin φ, cos φ, sin 2φ, and cos 2φ, as:

V_{R}=L+M·cos φ+N·sin φ+O·cos 2φ+P·sin 2φ (3)

By mathematics, we can get:

$$DC term \\ L = ( zz ) cos {β}_{R} cos {β}_{T} + cos ( α - γ ) \frac{( xx ) + ( yy )}{2} sin {β}_{R} sin {β}_{T} + sin ( α - γ ) \frac{( xy ) - ( yx )}{2} sin {β}_{R} sin {β}_{T} \\ {1}^{st} H Cos term \\ M = cos γ cos {β}_{R} sin {β}_{T} \cdot ( xz ) + sin γ cos {β}_{R} sin {β}_{T} \cdot ( yz ) + cos α sin {β}_{R} cos {β}_{T} \cdot ( zx ) + sin α sin {β}_{R} cos {β}_{T} \cdot ( zy ) \\ {1}^{st} H Sin term \\ N = - sin γ cos {β}_{R} sin {β}_{T} \cdot ( xz ) + cos γ cos {β}_{R} sin {β}_{T} \cdot ( yz ) - sin α sin {β}_{R} cos {β}_{T} \cdot ( zx ) + cos α sin {β}_{R} cos {β}_{T} \cdot ( zy ) \\ {2}^{nd} H Cos term \\ O = cos ( α + γ ) sin {β}_{R} sin {β}_{T} \frac{( xx ) - ( yy )}{2} + sin ( α + γ ) sin {β}_{R} sin {β}_{T} \frac{( xy ) + ( yx )}{2} \\ {2}^{nd} H Sin term \\ P = - sin ( α + γ ) sin {β}_{R} sin {β}_{T} \frac{( xx ) - ( yy )}{2} + cos ( α + γ ) sin {β}_{R} sin {β}_{T} \frac{( xy ) + ( yx )}{2} \qquad ( 4 )$$

The above equations show the five Fourier coefficients for one transmitter. Considering three collocated antenna with different azimuthal angles, we have 5×3=15 Fourier coefficients. It is enough to solve the coupling tensors. Next, we can solve the DC terms equations. We can solve coupling zz, xx+yy, and xy−yx from DC terms equations:

$$[ \begin{matrix}cos {β}_{R} cos {β}_{T} & cos ( α 1 - γ ) sin {β}_{R} sin {β}_{T} & sin ( α 1 - γ ) sin {β}_{R} sin {β}_{T} \\ cos {β}_{R} cos {β}_{T} & cos ( α 2 - γ ) sin {β}_{R} sin {β}_{T} & sin ( α 2 - γ ) sin {β}_{R} sin {β}_{T} \\ cos {β}_{R} cos {β}_{T} & cos ( α 2 - γ ) sin {β}_{R} sin {β}_{T} & sin ( α 3 - γ ) sin {β}_{R} sin {β}_{T}\end{matrix} ] \cdot [ \begin{matrix}( zz ) \\ \frac{( xx ) + ( yy )}{2} \\ \frac{( xy ) - ( yx )}{2}\end{matrix} ] = [ \begin{matrix}{L}_{α 1} \\ {L}_{α 2} \\ {L}_{a 3}\end{matrix} ] \qquad ( 5 )$$

Next, we can obtain:

$$\{ \begin{matrix}( zz ) = \frac{1}{3} ( {L}_{α 1} + {L}_{α 2} + {L}_{α 3} ) / ( cos {β}_{R} cos {β}_{T} ) \\ \frac{( xx ) + ( yy )}{2} = \frac{2}{3} ( \begin{matrix}{L}_{α 1} cos ( α 1 - γ ) + {L}_{α 2} cos ( α 2 - γ ) + \\ {L}_{α 3} cos ( α 3 - γ )\end{matrix} ) / ( sin {β}_{R} sin {β}_{T} ) \\ \frac{( xy ) - ( yx )}{2} = \frac{2}{3} ( \begin{matrix}{L}_{α 1} sin ( α 1 - γ ) + {L}_{α 2} sin ( α 2 - γ ) + \\ {L}_{α 3} sin ( α 3 - γ )\end{matrix} ) / ( sin {β}_{R} sin {β}_{T} )\end{matrix} \qquad ( 6 )$$

Next, we can solve the 1^{st} Harmonics terms equations. We can solve coupling xz, yz, zx, and zy from 1^{st} Harmonic terms equations:

$$[ \begin{matrix}cos γ cos {β}_{R} sin {β}_{T} & sin γ cos {β}_{R} sin {β}_{T} & cos α 1 sin {β}_{R} cos {β}_{T} & sin α 1 sin {β}_{R} cos {β}_{T} \\ - sin γ cos {β}_{R} sin {β}_{T} & cos γ cos {β}_{R} sin {β}_{T} & - sin α 1 sin {β}_{R} cos {β}_{T} & cos α 1 sin {β}_{R} cos {β}_{T} \\ cos γ cos {β}_{R} sin {β}_{T} & sin γ cos {β}_{R} sin {β}_{T} & cos α 2 sin {β}_{R} cos {β}_{T} & sin α 2 sin {β}_{R} cos {β}_{T} \\ - sin γ cos {β}_{R} sin {β}_{T} & sin γ cos {β}_{R} sin {β}_{T} & - sin α 2 sin {β}_{R} cos {β}_{T} & cos α 2 sin {β}_{R} cos {β}_{T} \\ cos γ cos {β}_{R} sin {β}_{T} & sin γ cos {β}_{R} sin {β}_{T} & cos α 3 sin {β}_{R} cos {β}_{T} & sin α 3 sin {β}_{R} cos {β}_{T} \\ - sin γ cos {β}_{R} sin {β}_{T} & cos γ cos {β}_{R} sin {β}_{T} & - sin α 3 sin {β}_{R} cos {β}_{T} & cos α3sin {β}_{R} cos {β}_{T}\end{matrix} ] \cdot [ \begin{matrix}( xz ) \\ ( yz ) \\ ( zx ) \\ ( zy )\end{matrix} ] = [ \begin{matrix}{M}_{α 1} \\ {N}_{α 1} \\ {M}_{α 2} \\ {N}_{α 2} \\ {M}_{α 3} \\ {N}_{α 3}\end{matrix} ] \\ with \\ \{ \begin{matrix}{M}_{α 1} = {( {1}^{st} Harmonic Cos )}_{1} \\ {L}_{α 1} = {( {1}^{st} Harmonic Sin )}_{1} \\ {M}_{α 2} = {( {1}^{st} Harmonic Cos )}_{2} \\ {L}_{α 2} = {( {1}^{st} Harmonic Sin )}_{2} \\ {M}_{α 3} = {( {1}^{st} Harmonic Cos )}_{3} \\ {L}_{α 3} = {( {1}^{st} Harmonic Sin )}_{3}\end{matrix} \qquad ( 7 )$$

This system of equations can be resolved by the least squares method. Next, we can solve the 2^{nd} Harmonics terms equations. We can solve coupling (xx−yy), and (xy+yx) from 2^{nd} Harmonic terms equations:

$$[ \begin{matrix}cos ( α 1 + γ ) sin {β}_{R} sin {β}_{T} & sin ( α 1 + γ ) sin {β}_{R} sin {β}_{T} \\ - sin ( α 1 + γ ) sin {β}_{R} sin {β}_{T} & cos ( α 1 + γ ) sin {β}_{R} sin {β}_{T} \\ cos ( α 2 + γ ) sin {β}_{R} sin {β}_{T} & sin ( α2 + γ ) sin {β}_{R} sin {β}_{T} \\ - sin ( α 2 + γ ) sin {β}_{R} sin {β}_{T} & cos ( α 2 + γ ) sin {β}_{R} sin {β}_{T} \\ cos ( α 3 + γ ) sin {β}_{R} sin {β}_{T} & sin ( α3 + γ ) sin {β}_{R} sin {β}_{T} \\ - sin ( α3 + γ ) sin {β}_{R} sin {β}_{T} & cos ( α3 + γ ) sin {β}_{R} sin {β}_{T}\end{matrix} ] \cdot [ \begin{matrix}\frac{( xx ) - ( yy )}{2} \\ \frac{( xy ) + ( yx )}{2}\end{matrix} ] = [ \begin{matrix}{O}_{α 1} \\ {P}_{α 1} \\ {O}_{α 2} \\ {P}_{α 2} \\ {O}_{α 3} \\ {P}_{α 3}\end{matrix} ] \\ with \\ \{ \begin{matrix}{O}_{α 1} = {( {2}^{nd} Harmonic Cos )}_{1} \\ {P}_{α 1} = {( {2}^{nd} Harmonic Sin )}_{1} \\ {O}_{α 2} = {( {2}^{nd} Harmonic Cos )}_{2} \\ {P}_{α 2} = {( {2}^{nd} Harmonic Sin )}_{2} \\ {O}_{α 3} = {( {2}^{nd} Harmonic Cos )}_{3} \\ {P}_{α 3} = {( {2}^{nd} Harmonic Sin )}_{3}\end{matrix} \qquad ( 8 )$$

This system of equations can be resolved by the least squares method. Next, we can handle rotation upon the apparent dip-azimuth angle. Resolving previous equations gave us approximations of:

$$First harmonics \text{:} ( xz ) , ( yz ) , ( zx ) , ( zy )$$

$$Second harmonics \text{:} \frac{( xx ) - ( yy )}{2} , \frac{( xy ) + ( yx )}{2}$$

$$DC \text{:} \frac{( xx ) + ( yy )}{2} , \frac{( xy ) - ( yx )}{2} , ( zz )$$

Up to this point the x-, y-, and z-axes correspond to a coordinate system attached to the tool, where the z-axis is the axis of the tool oriented toward the bit, the x-axis indicates the top of the borehole, and the y-axis completes a direct coordinate system. In a planar formation, some cross-coupling are zero. More precisely, if the planes of a layered formation are orthogonal to x, then (yz), (zy), and (xy)+(yx) are zero.

A DANG angle θ is used to rotate the coupling tensors from the original coordinate system, described above, to a new coordinate system which has a Z-axis matching the z-axis, an X-axis perpendicular to the formation layer, and a Y-axis perpendicular to the Z-axis and the X-axis. After rotation, the DC terms don't change, 1st Harmonic and 2nd harmonic terms change according to the formulas below:

$$DC terms ( not affected by rotation ) \text{:}$$

$$\{ \begin{matrix}\frac{( XX ) + ( YY )}{2} = \frac{( xx ) + ( yy )}{2} \\ \frac{( XY ) - ( YX )}{2} = \frac{( xy ) - ( yx )}{2} \\ ( ZZ ) = ( zz )\end{matrix} \\ 1 st Harmonic terms \text{:} \{ \begin{matrix}( ZX ) = ( zx ) * cos ( θ ) - ( zy ) * sin ( θ ) \\ ( ZY ) = ( zx ) * sin ( θ ) + ( zy ) * cos ( θ ) \\ ( XZ ) = ( xz ) * cos ( θ ) + ( yz ) * sin ( θ ) \\ ( YZ ) = - ( xz ) * sin ( θ ) + ( yz ) * cos ( θ )\end{matrix} \\ 2 nd Harmonic terms \text{:} \\ \{ \begin{matrix}\frac{( XX ) - ( YY )}{2} = \frac{( xx ) - ( yy )}{2} * cos ( 2 θ ) - \frac{( xy ) + ( yx )}{2} * sin ( 2 θ ) \\ \frac{( XY ) + ( YX )}{2} = \frac{( xy ) - ( yx )}{2} * sin ( 2 θ ) + \frac{( xy ) + ( yx )}{2} * cos ( 2 θ )\end{matrix}$$

The DANG angle θ can use either 1st harmonic (ANFH) or 2nd harmonic (ANSH) terms. After the rotation, we get:

$$1 st Harmonic terms \text{:} \frac{( XX ) - ( YY )}{2 ( ZZ )} , \frac{( XY ) + ( YX )}{2 ( ZZ )}$$

$$2 nd harmonic terms \text{:} \frac{( XY )}{( ZZ )} , \frac{( YX )}{( ZZ )} , \frac{( XZ )}{( ZZ )} , \frac{( ZX )}{( ZZ )}$$

$$Unchanged DC terms \text{:} \frac{( XX ) + ( YY )}{2 ( ZZ )} , \frac{( XY ) - ( YX )}{2 ( ZZ )}$$

The measurement channels can be calculated from those terms as follows:

$$Symmetrized Directional Attenuation \text{:}$$

$$USDA = - 20 \cdot {log}_{10} \{ \frac{( ZZ ) + ( XZ )}{( ZZ ) - ( XZ )} \cdot \frac{( ZZ ) - ( ZX )}{( ZZ ) + ( ZX )} \}$$

$$Anti \text{-} Symmetrized Directional Attenuation \text{:}$$

$$UADA = - 20 \cdot {log}_{10} \{ \frac{( ZZ ) + ( XZ )}{( ZZ ) - ( XZ )} \cdot \frac{( ZZ ) + ( ZX )}{( ZZ ) - ( ZX )} \}$$

$$Harmonic Resistivity Attenuation \text{:}$$

$$UHRA = 20 \cdot {log}_{10} \{ \frac{- 2 ( ZZ )}{( XX ) + ( YY )} \}$$

$$Harmonic Anisotropy Attenuation \text{:}$$

$$UHAA = - 20 \cdot {log}_{10} \{ \frac{( XX )}{( YY )} \}$$

$$3 D \text{-} Directional Attenuation : \\ 3 DFA = - 20 \cdot {log}_{10} \{ \frac{( ZZ ) + ( YZ )}{( ZZ ) - ( YZ )} \cdot \frac{( ZZ ) - ( ZY )}{( ZZ ) + ( ZY )} \}$$

$$Symmetrized Directional Phase Shift \text{:}$$

$$USDP = angle \{ \frac{( ZZ ) + ( XZ )}{( ZZ ) - ( XZ )} \cdot \frac{( ZZ ) - ( ZX )}{( ZZ ) + ( ZX )} \}$$

$$Anti \text{-} Symmetrized Directional Phase Shift \text{:}$$

$$UADP = angle \{ \frac{( ZZ ) + ( XZ )}{( ZZ ) - ( XZ )} \cdot \frac{( ZZ ) + ( ZX )}{( ZZ ) - ( ZX )} \}$$

$$Harmonic Resistivity Phase Shift \text{:}$$

$$UHRP = - angle \{ \frac{- 2 ( ZZ )}{( XX ) + ( YY )} \}$$

$$Harmonic Anisotrophy Phase Shift \text{:}$$

$$UHAP = angle \{ \frac{( XX )}{( YY )} \}$$

$$3 D \text{-} Directional Phase Shift \text{:}$$

$$3 DFP = angle \{ \frac{( ZZ ) + ( YZ )}{( ZZ ) - ( YZ )} \cdot \frac{( ZZ ) - ( ZY )}{( ZZ ) + ( ZY )} \}$$

If option 7 is selected and the tilt angle β is used in just the simulated voltage generation portion of method 200, then the following computational procedures can be used. When the measurements are constructed, ratios are used for the UHRA and UHRP measurement calculation. An example ratio follows:

$$\frac{( xx ) + ( yy )}{2 ( zz )}$$

Therefore, the tilt angles' impact in the measurement construction is as a scaling factor. The nominal tilt angle of 45° is in the measurement construction when solving the couplings from the fitting coefficients, and we do not expect it to cause any difference in the inversion, since measurements input are just attenuation and phase shift, but not the real resistivity through transform. Thus, in solving the DC terms equations, equation 5 simplifies to:

$$\frac{1}{2} [ \begin{matrix}1 & cos ( α 1 - γ ) & sin ( α 1 - γ ) \\ 1 & cos ( α 2 - γ ) & sin ( α 3 - γ ) \\ 1 & cos ( α 2 - γ ) & sin ( α 3 - γ )\end{matrix} ] \cdot [ \begin{matrix}( zz ) \\ \frac{( xx ) + ( yy )}{2} \\ \frac{( xy ) - ( yx )}{2}\end{matrix} ] = [ \begin{matrix}{L}_{α 1} \\ {L}_{α 2} \\ {L}_{a 3}\end{matrix} ] \qquad ( 9 )$$

Next, we can get:

$$\begin{matrix}\{ \begin{matrix}( zz ) = \frac{2}{3} ( {L}_{α 1} + {L}_{α 2} + {L}_{α 3} ) \\ \frac{( xx ) + ( yy )}{2} = \frac{4}{3} ( {L}_{α 1} cos ( α 1 - γ ) + {L}_{α 2} cos ( α 2 - γ ) + {L}_{α 3} cos ( α 3 - γ ) ) \\ \frac{( xy ) - ( yx )}{2} = \frac{4}{3} ( {L}_{α 1} sin ( α 1 - γ ) + {L}_{α 2} sin ( α 2 - γ ) + {L}_{α 3} sin ( α 3 - γ ) )\end{matrix} & ( 10 )\end{matrix}$$

Next, in solving the 1^{st} Harmonic, equation 7 simplifies to:

$$\frac{1}{2} [ \begin{matrix}cos γ & sin γ & cos α 1 & sin α 1 \\ - sin γ & cos γ & - sin α 1 & cos α 1 \\ cos γ & sin γ & cos α 2 & sin α 2 \\ - sin γ & sin γ & - sin α 2 & cos α 2 \\ cos γ & sin γ & cos α 3 & sin α 3 \\ - sin γ & cos γ & - sin α 3 & cos α 3\end{matrix} ] \cdot [ \begin{matrix}( xz ) \\ ( yz ) \\ ( zx ) \\ ( zy )\end{matrix} ] = [ \begin{matrix}{M}_{α 1} \\ {N}_{α 1} \\ {M}_{α 2} \\ {N}_{α 2} \\ {M}_{α 3} \\ {N}_{α 3}\end{matrix} ] \\ \{ \begin{matrix}{M}_{α 1} = {( {1}^{st} Harmonic Cos )}_{1} \\ {L}_{α 1} = {( {1}^{st} Harmonic Sin )}_{1} \\ {M}_{α 2} = {( {1}^{st} Harmonic Cos )}_{2} \\ {L}_{α 2} = {( {1}^{st} Harmonic Sin )}_{2} \\ {M}_{α 3} = {( {1}^{st} Harmonic Cos )}_{3} \\ {L}_{α 3} = {( {1}^{st} Harmonic Sin )}_{3}\end{matrix} \qquad ( 11 )$$

This system of equations can be resolved by Least Squares. We can solve coupling xz, yz, zx, and zy from 1^{st} Harmonic terms equations. Next, in solving the 2^{nd} Harmonic, we can get:

$$\frac{1}{2} [ \begin{matrix}cos ( α 1 + γ ) & sin ( α 1 + γ ) \\ - {sin ( α 1 + γ )}_{T} & cos ( α 1 + γ ) \\ cos ( α 2 + γ ) & sin ( α 2 + γ ) \\ - sin ( α 2 + γ ) & cos ( α 2 + γ ) \\ cos ( α 3 + γ ) & sin ( α 3 + γ ) \\ - sin ( α 3 + γ ) & cos ( α 3 + γ )\end{matrix} ] \cdot [ \begin{matrix}\frac{( xx ) - ( yy )}{2} \\ \frac{( xy ) + ( yx )}{2}\end{matrix} ] = [ \begin{matrix}{O}_{α 1} \\ {P}_{α 1} \\ {O}_{α 2} \\ {P}_{α 2} \\ {O}_{α 3} \\ {P}_{α 3}\end{matrix} ] , \\ \{ \begin{matrix}{O}_{α 1} = {( {2}^{nd} Harmonic Cos )}_{1} \\ {P}_{α 1} = {( {2}^{nd} Harmonic Sin )}_{1} \\ {O}_{α 2} = {( {2}^{nd} Harmonic Cos )}_{2} \\ {P}_{α 2} = {( {2}^{nd} Harmonic Sin )}_{2} \\ {O}_{α 3} = {( {2}^{nd} Harmonic Cos )}_{3} \\ {P}_{α 3} = {( {2}^{nd} Harmonic Sin )}_{3}\end{matrix} \qquad ( 12 )$$

This system of equations can also be resolved by Least Squares. The rotation upon the apparent dip-azimuth angle part and definition of output channels keep the same without any changes, as presented above.

If option 4 is selected and the tilt angle β is used in just the physical measurement construction portion of method 200, then tilt angles β can be tracked at the downhole firmware and the following computational procedures can be used. The physical measurement generation and simulated measurement generation can be the same (there will be no scaling factor), equations 5-8 can be skipped, and equations 9-12 can be used for measurement construction.

A few example embodiments have been described in detail above; however, those skilled in the art will readily appreciate that many modifications are possible in the example embodiments without materially departing from the scope of the present disclosure or the appended claims. Accordingly, such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scope of the disclosure and the appended claims. Additions, deletions and modifications to the embodiments that fall within the meaning and scopes of the claims are to be embraced by the claims.

Certain embodiments and features may have been described using a set of numerical upper limits and a set of numerical lower limits. It should be appreciated that ranges including the combination of any two values, e.g., the combination of any lower value with any upper value, the combination of any two lower values, or the combination of any two upper values are contemplated. Certain lower limits, upper limits and ranges may appear in one or more claims below. Numerical values are “about” or “approximately” the indicated value, and take into account experimental error, tolerances in manufacturing or operational processes, and other variations that would be expected by a person having ordinary skill in the art.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include other possible embodiments along with the full scope of equivalents to which such claims are entitled. Accordingly, the claims are not limited by the disclosure.

1. A method comprising:
drilling a borehole with a drill string including an antenna;
predicting voltages to be outputted by the antenna of the drill string during logging while drilling investigations of a geologic formation using an actual effective tilt angle of the antenna; and
processing the predicted voltages to generate predicted measurements of the geologic formation.

2. The method of claim 1, further comprising adjusting a drilling parameter based on the generated predicted measurements.

3. The method of claim 1 wherein the processing the predicted voltages includes using the actual effective tilt angle to generate the predicted measurements.

4. The method of claim 1, further comprising:
emitting electromagnetic waves from the drill string while the drill string is drilling the borehole;
receiving portions of the emitted electromagnetic waves returned to the antenna from the geologic formation;
outputting voltages corresponding to the received portions of the emitted electromagnetic waves from the antenna; and
processing the outputted voltages to generate physical measurements of the geologic formation using the actual effective tilt angle of the antenna.

5. The method of claim 4, further comprising adjusting a drilling parameter based on the generated physical measurements.

6. The method of claim 4 wherein the processing the predicted voltages includes using the actual effective tilt angle to generate the predicted measurements.

7. The method of claim 1, wherein the drill string includes an electromagnetic transmitter and the predicting voltages includes using an actual effective tilt angle of the transmitter.

8. The method of claim 4, further comprising comparing the generated predicted measurements to the generated physical measurements.

9. The method of claim 8, wherein a forward modeling simulation is used to predict the voltages and the method further comprises refining the forward modelling simulation based on the comparison.

10. A method comprising:
emitting electromagnetic waves from a drill string including an antenna while the drill string is used to drill a borehole;
receiving portions of the emitted electromagnetic waves returned to the antenna from a geologic formation;
outputting voltages corresponding to the received portions of the emitted electromagnetic waves from the antenna; and
processing the outputted voltages to generate measurements of the geologic formation using an actual effective tilt angle of the antenna.

11. The method of claim 10, further comprising adjusting a drilling parameter based on the generated measurements.

12. The method of claim 10, wherein the drill string includes an electromagnetic transmitter and the processing the outputted voltages includes using an actual effective tilt angle of the transmitter.

13. A system comprising:
one or more processors;
memory operatively coupled to the one or more processors; and
processor-executable instructions stored in the memory and executable by at least one of the processors to instruct the system to:
predict voltages to be outputted by an antenna of a drill string during logging while drilling investigations of a geologic formation using an actual effective tilt angle of the antenna; and
process the predicted voltages to generate predicted measurements of the geologic formation.

14. The system of claim 13, further comprising instructions to instruct the system to adjust a drilling parameter based on the generated predicted measurements.

15. The system of claim 13 wherein the processing the predicted voltages includes using the actual effective tilt angle to generate the predicted measurements.

16. The system of claim 13, further comprising instructions to instruct the system to:
process outputted voltages corresponding to received portions of emitted electromagnetic waves from the antenna, to generate physical measurements of the geologic formation using the actual effective tilt angle of the antenna.

17. The system of claim 16, further comprising instructions to instruct the system to adjust a drilling parameter based on the generated physical measurements.

18. The system of claim 16 wherein processing the predicted voltages includes using the actual effective tilt angle to generate the predicted measurements.

19. The system of claim 16, further comprising instructions to instruct the system to compare the generated predicted measurements to the generated physical measurements.

20. The system of claim 19, wherein a forward modeling simulation is used to predict the voltages and the system further comprises instructions to instruct the system to refine the forward modelling simulation based on the comparison.
